(19) United States
(12) Patent Application Publication
(10) Pub. No.: US 2012/0180908 A1
(43) Pub. Date: Jul. 19, 2012

(54) Bamboo Material Embossing Method

(75) Inventor: YONGBING WANG, Huzhou (CN)

(73) Assignee: Zhejiang Yongyu Bamboo Joint-Stock Company Co., Ltd., Huzhou (CN)

(21) Appl. No.: 13/008,438

(22) Filed: Jan. 18, 2011

(51) Int. Cl. B27J 7/00

(52) U.S. Cl. 144/333

(57) ABSTRACT

The invention discloses one bamboo material embossing method, which includes following steps; a. Preparing material: bleached or carbonized bamboo material is cut into segments according to demand; b. Embossing: bamboo material cut in step a is placed into rolling mill and is conveyed at speed of 8-12 m/min when press roller of rolling mill is heated to 80-95° C.; pattern pressing is made at pressure of 5˜8 mpa; c. Stress releasing; bamboo material with embossing completed is placed for twelve hours for stress releasing; d. Varnish painting; varnish is painted for bamboo material with stress releasing completed. Through the method of the invention, woody texture can be produced on the surface of bamboo material and decoration material having elegant woody texture can be produced through using energy-saving and environmental-protection bamboo material. Furthermore, the method does not pollute environment and has low energy consumption and very low cost.

### FIELD OF THE INVENTION

The invention involves technical field of decoration sheet material, more specifically involves one method embossing bamboo material.

### BACKGROUND OF THE INVENTION

Area of bamboo forest in China reaches more than five million hectares; both area and output of bamboo resources in China rank the first in the world. About ninety percent of mao bamboo forest with the most excellent performance and the highest utility value in the world is distributed in each southern province of China.

However, China has been facing the contradiction of demand exceeding supply for wooden material. With Copenhagen Climate Conference dropping the curtain, the idea of “energy saving, environmental protection and low carbon” strikes deep root in the hearts of the people in the world. Using bamboo to replace wooden with the purpose of energy saving and environmental protection provides good development opportunity for developing and using resourceful bamboo material.

Texture of bamboo material is concise and straight, which brings lively sense to people. People have used wooden material as decoration material for long term time. Although wooden resources are increasingly badly needed, their aesthetic preference on woody texture cannot be thoroughly changed within short period yet. How to use energy-saving and environmental-protection bamboo material to produce decoration material having elegant woody texture, to guide aesthetic idea of consumers to be transformed increasingly becomes on key point for research and development of enterprises.

### SUMMARY OF THE INVENTION

The invention has the purpose providing one method embossing bamboo material used for pressing woody texture on bamboo material, which can provide one bamboo material having woody texture and stereoscopic sense.

The invention provides technical solutions as below:

One bamboo material embossing method is characterized in comprising following steps:

a. preparing material: bleached or carbonized bamboo material is cut into segments according to demand;

b. embossing: segments gotten from the step a are placed into a rolling mill for rolling, the rolling speed is 8-12 m/min, a press roller of the rolling mill is heated to 80-95° C.; pattern rolling is made at pressure of 5-8 mpa;

c. stress releasing: segments after rolling are placed for twelve hours for stress releasing;

d. varnish painting: varnish painting is made for the segments after rolling with stress releasing completed.

It is preferred that the press roller of the rolling mill in step b is heated to 90° C.

The varnish of the invention only consists of resin (film material) or solvent (sometimes a little additive will be added according to requirement of performance). Because paint and coating film are transparent, they are also called as transparent paint. Varnish which is often used includes phenolic aldehyde varnish, alcohol acid varnish, Polyurethane varnish and acrylic acid varnish etc.

The invention has beneficial effects as below compared to prior art: Through the method of the invention, woody texture can be produced on the surface of bamboo material; produce decoration material having elegant woody texture can be produced through using energy-saving and environmental-protection bamboo material, so “bamboo material can be used for replacing wooden material”, which greatly expands application scope of bamboo material, makes bamboo material replace substantive wooden material for being processed and used, saves substantive wooden material, reduces forestry harvest volume and protects environment. Furthermore, the method does not pollute environment and has low energy consumption and very low cost.

### BRIEF DESCRIPTION OF THE DRAWING

FIG. 1: the technical process flow of this invention.

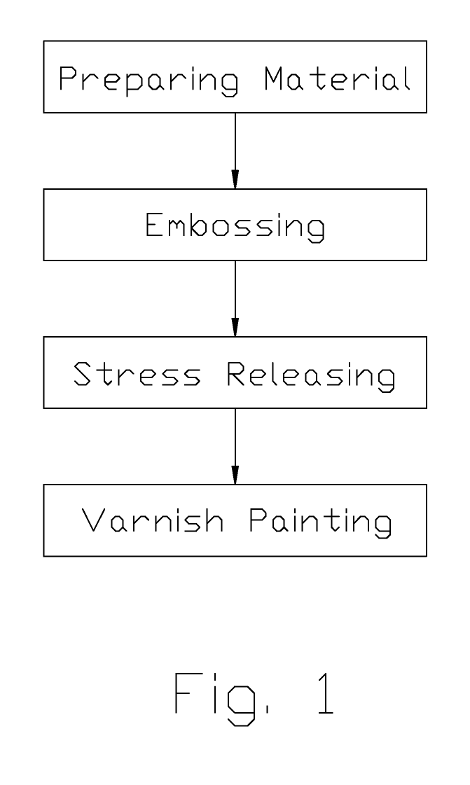

### DETAILED DESCRIPTION OF THE INVENTION

Following are only better embodiments described for the invention. So we do not limit protection range of the invention.

### Embodiment 1

One bamboo material embossing method includes following steps:
a. Preparing material; bleached bamboo material is cut into sheet material with length of 2 m, width of 125 mm and thickness of 5 mm;
b. Embossing: bamboo material cut in step a is placed into rolling mill and is conveyed at speed of 8 m/min when press roller of rolling mill is heated to 80° C.; pattern pressing is made at pressure of 7 mpa;
c. Stress releasing: bamboo material with embossing completed is placed for twelve hours for stress releasing;
d. Varnishing: use Nippon two-component polyurethane wood varnish (belonging to polyurethane varnish) for varnishing bamboo material with stress releasing completed for varnishing.

### Embodiment 2

One bamboo material embossing method includes following steps:
a. Preparing material: bleached bamboo material is cut into sheet material with length of 2 m, width of 125 mm and thickness of 3 mm;
b. Embossing: bamboo material cut in step a is placed into rolling mill and is conveyed at speed of 12 m/min and press roller of rolling mill is heated to 95° C.; pattern pressing is made at pressure of 5 mpa;
c. Stress releasing: bamboo material with embossing completed is placed for twelve hours for stress releasing;
d. Painting: use new generation of two-component polyurethane wood varnish (belonging to polyurethane varnish) of Nippon for varnishing bamboo material with stress releasing completed.

### Embodiment 3

One bamboo material embossing method includes following steps:
a. Preparing material: bleached bamboo material is cut into sheet material with length of 2 m, width of 125 mm and thickness of 4 mm;
b. Embossing: bamboo material cut in step a is placed into rolling mill and conveyed at speed of 10 m/min when press roller of rolling mill is heated to 90° C.; pattern pressing is made at pressure of 6 mpa;
c. Stress releasing: bamboo material with embossing completed is placed for twelve hours for stress releasing;
d. Painting: use new generation of two-component polyurethane wood varnish (belonging to polyurethane varnish) of Nippon for varnishing bamboo material with stress releasing completed.

### Embodiment 4

One bamboo material embossing method includes following steps:
a. Preparing material; bleached bamboo material is cut into sheet material with length of 3 m, width of 125 mm and thickness of 8 mm;
b. Embossing: bamboo material cut in step a is placed into rolling mill and conveyed at speed of 8 m/min when press roller of rolling mill is heated to 95° C.; pattern pressing is made at pressure of 8 mpa;
c. Stress releasing: bamboo material with embossing completed is placed for twelve hours for stress releasing;
d. Painting: use Nippon two-component polyurethane wood varnish (belonging to polyurethane varnish) of Nippon for varnishing bamboo material with stress releasing completed.

What is claimed is:

1. A bamboo material embossing method comprising following steps.
a. preparing material: bleached or carbonized bamboo material is cut into segments according to demand;
b. embossing; segments gotten from the step a are placed into a rolling mill for rolling, the rolling speed is 8-12 m/min, a press roller of the rolling mill is heated to 80-95° C.; pattern rolling is made at pressure of 5-8 mpa;
c. stress releasing: segments after rolling are placed for twelve hours for stress releasing;
d. varnish painting: varnish painting is made for the segments after rolling with stress releasing completed.

2. The bamboo material embossing method as described in claim 1, wherein the press roller of the rolling mill is step b is heated to 90° C.
